(19) United States
(12) Patent Application Publication
(10) Pub. No.: US 2024/0311775 A1
(43) Pub. Date: Sep. 19, 2024

(54) SYSTEMS AND METHODS FOR MATERIAL ASSESSMENT

(71) Applicant: Genehome, Inc., Playa Vista, CA (US)

(72) Inventor: Steven Rogall, Playa Vista, CA (US)

(73) Assignee: Genehome, Inc., Playa Vista, CA (US)

(21) Appl. No.: 18/607,092

(22) Filed: Mar. 15, 2024

Related U.S. Application Data
(60) Provisional application No. 63/452,228, filed on Mar. 15, 2023.

(51) Int. Cl. G06Q 10/20; G01N 9/36; G05D 1/60; G05D 105/80; G05D 107/90; G05D 109/20; G05D 111/10; G06Q 30/0283

(52) U.S. Cl. CPC G06Q 10/20; G01N 9/36; G05D 1/60; G06Q 30/0283; G05D 2105/89; G05D 2107/90; G05D 2109/20; G05D 2111/10

(57) ABSTRACT

A system for assessing condition of materials. The system includes a scanning device including a scanning vehicle and one or more scanning sensors and a control device in electronic communication with the scanning device. The control device includes one or more processors and a memory containing processor-executable instructions that, when executed by the one or more processors, cause the one or more processors to transmit instruction to the scanning vehicle to move with respect to a structure, transmit instructions to the one or more scanning sensors to capture data associated with one or more materials of the structure, receive sensor data from the one or more scanning sensors, and, based on the sensor data, determine a condition of each of the one or more materials of the structure.

### CROSS-REFERENCES TO RELATED APPLICATIONS

This application claims priority to U.S. Provisional Application No. 63/452,228, filed Mar. 15, 2023, the entirety of which is incorporated by reference herein.

### TECHNICAL FIELD

The present disclosure relates generally to the field of imaging technology and, more specifically, using imaging and other sensor technology in assessing materials.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Structural and other components of buildings, homes, structures, vehicles, etc., may experience wear or other degradation over their lifetimes and periodically need replacement, repair, or other maintenance. Accordingly, understanding the condition of structural and/or non-structural components, building components, decorative and non-decorative features, substrates, utility components, and other materials may aid in determining when such maintenance or repairs may be useful. Traditionally, it has been difficult to identify, diagnose, and/or track material maintenance needs across a wide range of applications, (e.g., homes, buildings, bridges, roads, vehicles, utilities, etc.).

As just one example, owners of homes and other structures may periodically need to replace or repair substrates of the structure, such as exterior or interior walls, roofing, etc. Traditionally, there has been no standard procedure for assessing the condition of building substrates, which may lead to late detection of substrate degradation, unpredictability of maintenance timing or costs, lack of accuracy in assessing substrate or other material conditions, high costs, and other inefficiencies. Systems are needed that will help with diagnosing, tracking, and maintenance related to the soundness, durability, and longevity of substrates in a fast, accurate, and efficient way.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a system for assessing condition of building substrates. The system may include a scanning device including a scanning vehicle and one or more scanning sensors and a control device in electronic communication with the scanning device. The control device may include one or more processors and a memory containing processor-executable instructions that, when executed by the one or more processors, cause the one or more processors to transmit instruction to the scanning vehicle to move with respect to a building, transmit instructions to the one or more scanning sensors to capture data associated with one or more substrates of the building, receive sensor data from the one or more scanning sensors, and, based on the sensor data, determine a condition of each of the one or more substrates of the building.

In another embodiment, the disclosure describes a computer-implemented method of assessing condition of building substrates. The method may include determining, via a control device, a scanning pattern for a building that includes one or more building substrates. The method may include transmitting, from the control device to a scanning vehicle, the scanning pattern instructing the scanning vehicle to capture data associated with the one or more building substrates via one or more scanning sensors on the scanning vehicle. The method may include receiving, from the scanning vehicle, sensor data from the one or more scanning sensors. The method may also include, based on the sensor data, determining, by the control device, a condition of each of the one or more substrates of the building.

In another embodiment, the disclosure describes a system for assessing condition of building substrates. The system may include a scanning device including an aerial drone and one or more scanning sensors mounted to the aerial drone. The system may include a control device in electronic communication with the scanning device, the control device including one or more processors and a memory containing processor-executable instructions that, when executed by the one or more processors, cause the one or more processors to determine a flight pattern and scanning pattern for a building that includes one or more building substrates. The instructions may also cause the one or more processors to transmit the flight plan to the aerial drone. The flight plan may include instructions for the aerial drone to move with respect to the building. The instructions may also cause the one or more processors to transmit the scanning pattern to the scanning sensors, where the scanning pattern may include instructions to capture data associated with the one or more substrates of the building. The instructions may also cause the one or more processors to receive sensor data from the one or more scanning sensors. Based on the sensor data, he instructions may cause the one or more processors to determine a condition of each of the one or more substrates of the building by comparing a measured value of a substrate property to a baseline value of the substrate property.

In another embodiment, the disclosure describes a system for assessing condition of structure materials. The system may include a scanning device with one or more sensors, and a control device in electronic communication with the scanning device. The control device may include one or more processors and a memory containing processor-executable instructions that, when executed by the one or more processors, cause the one or more processors to determine a scanning pattern for a structure that includes one or more materials. The instructions may also cause the one or more processors to transmit the scanning pattern to the scanning device, retrieve contextual data associated with the structure, and receive sensor data from the one or more sensors. The instructions may also cause the one or more processors to, based on the sensor data, determine a condition of each of the one or more materials of the structure by comparing a measured value of a material property to a baseline value of the material property. The instructions may also cause the one or more processors to, based on the senor data and the contextual data, determine a maintenance schedule for the structure.

### BRIEF DESCRIPTION OF THE DRAWINGS

Non-limiting and non-exhaustive embodiments are described in reference to the following drawings. The components in the figures are not necessarily to scale, emphasis instead being placed upon illustrating the principles of the disclosure. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1 is a schematic illustration of an embodiment of a scanning system in accordance with the disclosure;

FIG. 2 is a schematic illustration of elements of an embodiment of an example computing device;

FIG. 3 is a schematic illustration of elements of an embodiment of a server type computing device;

FIG. 4 is a flow chart of an embodiment of a method of using the scanning system and application in accordance with the disclosure; and

FIG. 5 is a flow of another embodiment of a method of using the scanning system and application in accordance with the disclosure.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references. The meaning of “in” includes “in” and “on.”

Traditionally, detecting and tracking degradation and deterioration of structures (e.g., homes, buildings, infrastructure, utilities, roads, etc.) non-structural components (e.g. furnishings, equipment, electrical and mechanical fixtures, architectural features (e.g., suspended ceilings), storage cabinets, shelves, and glass), or components of either has been difficult, particularly with accuracy and over time. For example, changes to the condition of components may go unnoticed because inspectors, owners, and other maintenance personnel may only look for or notice changes to the surface of a building substrate, structural or non-structural components, exterior and interior features, and other matters pertaining to property inspections. Further, traditional methods of diagnosing building material health may not be standardized and accordingly may not allow for an inspector to reasonably assess early stages of deterioration or degradation, for example, on large scale substrates at a low degree of error. This may be particularly true at for components that may be more difficult to access, such as on roofs or on portions of buildings or other structures that may be disposed far from the ground or other access locations. Additionally, even if the condition of structure materials may be identified at a particular point in time, it may be difficult to ascertain and/or track when such materials may benefit from repairs or other maintenance in the future.

Accordingly, the disclosure describes, in some embodiments, systems and methods for assessing the condition of materials in a variety of contexts using imaging and sensor technology. The system may also, in some embodiments, include systems for making predictions about material health over time based on numerous inputs, such as sensed imagery, present conditions, geography, climate conditions, exposure, usage, etc.

In a non-limiting example, the systems and methods may help identify substrate and other material health of building components, homes, and other structures. These systems and methods may detect signs of damage and decay related to the health of the building substrates and other materials and, in some embodiments, detect those signs earlier than traditional inspection methods. In some embodiments, the systems and methods for material assessment may allow home/building owners, inspectors, or other parties to visibly see and identify early and late stage damage to substrates, protective paint films, utilities (e.g., HVAC and piping) and other materials. In some embodiments, the systems and methods may additionally assess current conditions of such materials, store those conditions, and make intelligent predictions about material conditions over time. In some embodiments, the system and methods may include software, hardware, and/or other components for tracking such material conditions and informing interested parties (e.g., home owners, building owners, maintenance personnel, etc.) as those conditions may be expected to change.

In some embodiments, the systems and methods may include comparing a target substrate or other building component at a particular structure to a baseline for that specific type of component based on historical data. This assessment may be supported by research and other predetermined properties of a particular type of substrate or other building material, data on conditional changes based on climate and other contextual factors, age of the material, etc. In some embodiments, deep machine learning, generative artificial intelligence (AI), and other computational methods may be used to assess the condition of a particular material based on historical data sets and other sources. Such systems and methods may provide for a way to detect potential construction or other substrate material problems relatively early, and/or alert interested parties when degradation and other problems may be expected. In some embodiments, early detection and tracking may help limit damage and costs associated with repairing that damage, or even identify upcoming problems before they occur. In some embodiments, standardizing what may be considered a “sound” or “healthy” substrate on the exterior of a home or other structure may provide owners and/or other parties with an easier, more consistent way to understand substrate and other building material health as opposed to more subjective assessments. Such information may provide building owners, managers, inspectors, etc., with valuable information to make informed decisions regarding building and other structural and/or non-structural maintenance and costs for their property or properties for which they may be responsible.

In some embodiments, the systems and methods may include providing “check-ups” for homes or other target structures. Those check-ups may include using inputs from one or more sensors and other inputs to establish a “snap shot” of the condition of one or more building components. In some embodiments, this may include scanning the building's substrates and other building materials with light- or optical-based devices, such as densitometry technology, to assess the condition of a substrate. In some embodiments, other types of sensor or imaging technology may include cameras, optical sensors, infrared sensors, densitometers, light sensors, proximity sensors, ultrasound sensors, radar, LIDAR, etc. In some embodiments, other inputs to constructing such a snap shot may include environmental factors, such as weather, humidity, exposure, temperature fluctuations over time, material age, etc. In some embodiments, such information may be identified automatically using various methods, such as GPS, historical weather data, and other contextual information available over the internet. In some embodiments, large language models (LLMs) or other Al tools maybe be used to query information regarding the particular location, materials, lifespan, etc. Additional inputs may be also be provided manually that may not be otherwise available, such as historical repairs, maintenance practices, etc.

In some embodiments, the systems and methods described herein may aid in assessing conditions of building, structural components, or non-structural components, such as a substrate, from the inside of the component to the outside, or from outside the component to the inside. This may provide earlier detection of damage or more thorough assessment of conditions that may not be visible to the human eye alone through exterior inspection. Additionally, traditional inspection methods may be limited by accessibility. For example, home or building inspections may traditionally be performed at ground level or via ladders. But due to poor accessibility, many small spaces and areas at heights or other locations that are not easily reachable by traditional methods (e.g., ladders) may not receive adequate inspection. As another example, many materials on bridges or other large structures may not be readily accessible without extensive equipment. By standardizing the substrate inspection process and providing means for accessing traditionally difficult to access areas, labor, cost, and human error may be reduced, and the disclosed systems and methods may result in an overall more efficient and accurate material assessment system. This may include home and other building inspection, structural integrity inspections for utilities and other infrastructure, which may be structural or non-structural, and other applications where a more complete and efficient understanding of material conditions may be advantageous. Accordingly, the disclosed systems, methods, and devices may perform substrate inspection and other material condition assessment faster, more reliably, and more efficiently than traditional inspection methods.

In some embodiments, the system and methods disclosed herein may determine the condition of building materials (e.g., a building substrate) and suggest the type of repairs or maintenance needed, suggest a timeline for when repairs may be needed, provide estimated costs for completing those repairs, and/or project the potential costs associated with delaying repairs. In some embodiments, the system may use predictive analytics, machine learning, generative Al, and/or other artificial intelligence techniques to make such determinations and suggestions. As a result, interested parties (e.g., homeowners, vehicle owners, maintenance personnel, service providers, etc.) may identify issues before they become visible to the human eye or even before they occur, and may provide solutions to repair or prevent damage before they worsen or become more expensive to repair. In some embodiments, the system may use densitometry and other forms of imagery, such as those described herein, to assess the well-being of substrates and other materials used in home or other building, structural or non-structural construction, and applications. In many instances, light, imagery, and other sensors may provide a more accurate “soundness” reading than traditional methods of assessing substrate and other material conditions. In some embodiments, the system may include establishing a baseline for each substrate and assessing the soundness of specific substrates against that baseline. In some embodiments, the system may use one or more predictive analytics, machine learning, generative artificial intelligence (AI), and/or other artificial intelligence techniques in its assessment of the soundness of a substrate. In some embodiments, the system may use other computational techniques, such as reference to databases, table look-ups, etc.

### Scanning System and Device

In some embodiments, the system includes one or more scanning devices that maybe mounted to an aerial drone or other vehicles configured to access various types of building substrates, structural and non-structural components, or other components in many locations (e.g., walls, roofs, chimneys, bridge footings and decks, roads, etc.). In some embodiments, the system may also or alternatively include a handheld device that may be used to access tight or other hard-to-reach areas of a home, building, or vehicle, such as crawl-spaces, interiors of walls, attics, engine blocks, etc. In some embodiments, the device may include an optical scanning device or other scanning technology, such as a densitometer, to measure the optical density of a substrate for use in determining properties of the substrate material. In some embodiments, other sensor technology may include optical or sonic sensing capabilities, such as cameras, optical sensors, infrared sensors, densitometers, light sensors, proximity sensors, ultrasound sensors, radar, LIDAR, etc. In some embodiments, the device may have GPS capabilities and may have access to the internet or other wide area or local area networks (WAN/LAN), or to databases of relevant contextual, environmental, and historical data. In some embodiments, using light and other imagery to assess substrate material conditions, such as material soundness and other properties, may be more accurate than other forms of material assessment, such as ultrasound.

In some embodiments, the system may assess the well-being or soundness of a material by establishing a baseline value or values for properties of each type of substrate material (e.g., wood, brick, plywood, siding, composite, stone, metal, steel, etc.) and assessing the soundness of each target substrate as compared to the baseline value. For example, cedar siding may have a predetermined baseline optical density value for a cedar siding that may be used as a point of comparison between an optical density value measured or sensed for a cedar siding substrate on a home or other structure. The comparison of the baseline value versus the measured or sensed value may be used to determine a current condition of the target substrate. In some embodiments, it is contemplated that substrate properties other than optical density or density may be used as a basis of comparison between a substrate property baseline and a measured substrate property. In some embodiments, the comparison of the baseline value versus the measured or sensed value may take into consideration additional factors such as temperature, humidity, weather, age, etc., that may be manually entered or may be ascertained automatically by the device.

In some embodiments, the device may also include one or more communications modules to send and/or receive data from one or more devices, such as a controlling device, user computing device, cloud server, cellular network, satellite, etc. The communication modules may include one or more antennas for communications protocols such as Bluetooth, Wifi, near field communication (NFC), radio frequency identification (RFID), etc., or may use optical communications such as infrared, laser, etc. The device may also include ports or other connections for wired communication with other devices, such as universal serial bus (USB) ports and other suitable connections. In some embodiments, the device may include geographical location technology, such as global positioning system (GPS).

In some embodiments, the scanning device, mounted to an aerial drone or other vehicle, may be operated to fly over a target structure or other object, such as a home, a building, a bridge, a fence, a pipeline, or other structure. The drone may be operated by an operator under manual control, or may be programmed to fly autonomously or semi-autonomously, such as based on a visual inspection of the building or using proximity or other sensing technology. During the target structure flyover, the scanning device may capture one or more images and other sensory data of the structure's components, such as the structure's substrates, supports, and other materials. Image and other sensor capturing may occur manually by an operator, or may be based on a pre-programed flight and/or image and sensor data capturing pattern and completed autonomously by the scanning device. In some embodiments, a control device in wireless communication with the aerial drone either directly or via the scanning device may include programming to instruct, such as via a graphical user interface (GUI), a drone or other vehicle operator where and/or in what pattern to fly the vehicle so as to provide the scanning device with appropriate views to capture images and other sensor data for assessment of the structures materials, substrates, etc. In some embodiments, the control device may be on site, or may be disposed at a remote location. In some embodiments, the control device may include a portable computing device (e.g., a smart phone, a tablet computer, a laptop computer, etc.), and/or may include other computing devices at remote locations (e.g., cloud servers, remote desktop computers, etc.). In some embodiments, the scanning device may operate independently of any separate control device.

In some embodiments, the scanning device may include one or more on-board computer processors and memory that may include computer-executable instructions to complete a pre-programed or autonomous image and/or sensor data capture based on the dimensions of the particular structure or object being scanned. In some embodiments, the vehicle and the scanning device may be in electronic communication with the onboard computer processor. In some embodiments, the computer executable instructions may be stored remotely from the vehicle or the scanning device, such as on a control device that may be used to locally or remotely control or otherwise operate the vehicle and/or scanning device. In some embodiments, the control device may be a specialized computing device configured for controlling the vehicle and/or scanning device, or may be any other suitable computing device such as a computer, laptop computer, tablet computer, mobile computing device, server computer, etc. In some embodiments, each of the vehicle, the scanning device, and the control device may have separately programmable computer processors and memory in electronic communication with one another.

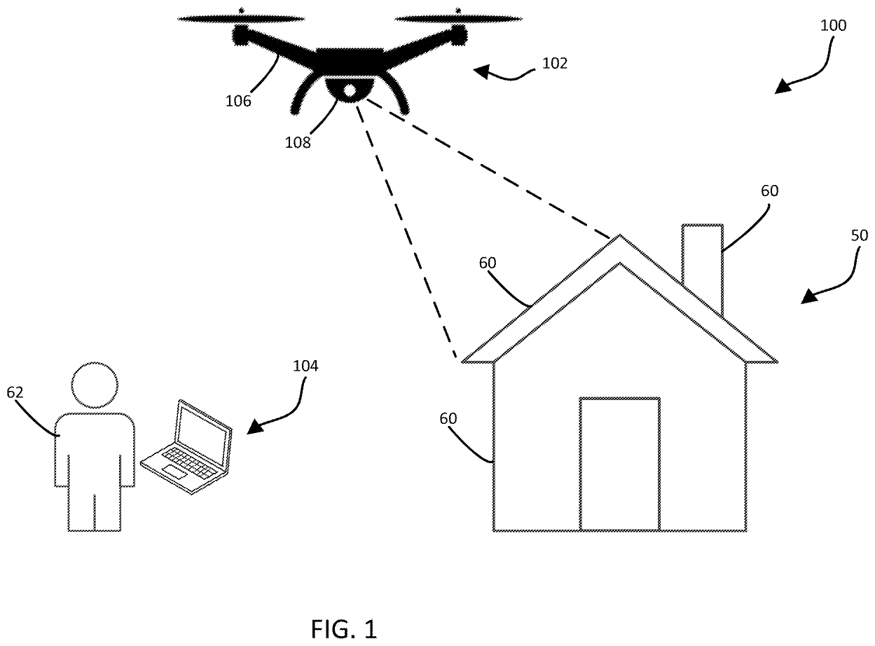

FIG. 1 shows a diagram of an embodiment of a scanning system 100 for assessing health of a building 50, such as by assessing the condition of its substrates, materials, and other building components. The system 100 may include a scanning device 102, a controller device 104, and one or more cloud servers (not shown) that may be in electronic communication with the scanning device and/or the control device. In some embodiments, the scanning device 102 may include a vehicle, such as an aerial drone 106, and one or more sensors 108. The one or more sensors 108 may include optical or sonic sensing capabilities, such as cameras, optical sensors, infrared sensors, densitometers, light sensors, proximity sensors, ultrasound sensors, radar, LIDAR, etc., or other suitable sensors for gathering data in accordance with the disclosure. The scanning device 102 may also include one or more antennas for wireless communication with the control devise 104 or other devices, as well as onboard processors, memory, and/or other computing and navigation systems. The control device 104 may be in electronic communication with the scanning device 102 to provide navigational instructions, image capturing and other sensing instructions, flight instructions, etc. As disclosed herein, the control device 104 may also directly or through remote computer resources use one or more of predictive analytics, machine learning, generative Al, and/or other artificial intelligence techniques to determine drone flight paths, assess substrate and/or other material conditions, determine repairs, repair costs, maintenance recommendations, timing, costs of delaying repairs, etc. In some embodiments, other computational or assessment techniques may also or alternatively be used to make such determinations. The building 50 may have one or more materials 60, such as substrates or other building materials, that may be the subject of inspection by the scanning system 100. The scanning device 102 may be configured to capture images and other sensor data related to each material 60 or of a subset of the materials as instructed by the operator 62 via the control device 104 and/or in response to predetermined flight and/or image and other sensor capture patterns.

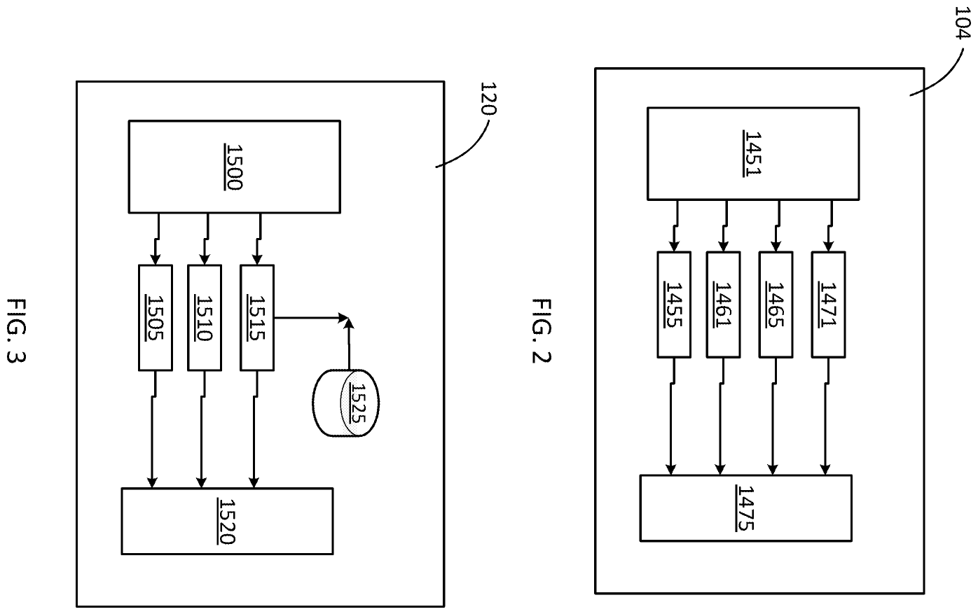

FIG. 2 is a simplified illustration of some physical elements that may make up an embodiment of a computing device, such as the controller device 104, and FIG. 3 is a simplified illustration of the physical elements that make up an embodiment of a server type computing device 120, such as may be used for remote cloud computing related to the scanning system 100 (e.g., as part of or in communication with the controller device 104). Referring to FIG. 2, a sample computing device 104 is illustrated that may be physically configured to be part of the scanning system 100. The computing device 104 may have a processor 1451 that is physically configured according to computer executable instructions. In some embodiments, the processor may be specially designed or configured to optimize communication between a server relating to the system described herein. The controller device 104 may have a portable power supply 1455 such as a battery, which may be rechargeable. It may also have a sound and video module 1461 which assists in displaying video and sound and may turn off when not in use to conserve power and battery life. The controller device 104 may also have volatile memory 1465 and non-volatile memory 1471. The controller device 104 may have GPS capabilities that may be a separate circuit or may be part of the processor 1451. There also may be an input/output bus 1475 that shuttles data to and from the various user input/output devices such as a microphone, a camera, a display, or other input/output devices. The controller device 104 also may control communicating with networks either through wireless or wired devices. Of course, this is just one embodiment of a controller device 104 and the number and types of computing devices 106 is limited only by the imagination.

The physical elements that make up an embodiment of a server, remote cloud server 120, are further illustrated in FIG. 3. In some embodiments, the server may be specially configured to run the scanning system 100 as disclosed herein. At a high level, the server 120 may include a digital storage such as a magnetic disk, an optical disk, flash storage, non-volatile storage, etc. Structured data may be stored in the digital storage a database. More specifically, the server 120 may have a processor 1500 that is physically configured according to computer executable instructions. In some embodiments, the processor 1500 can be specially designed or configured to optimize communication between a computing device, such as controller device 104, and A/V equipment or remote cloud server 120 as described herein. The server may also have a sound and video module 1505 which assists in displaying video and sound and may turn off when not in use to conserve power and battery life. The server 120 may also have volatile memory 1510 and non-volatile memory 1515.

A database 1525 for digitally storing structured data may be stored in the memory 1510 or 1515 or may be separate. The database 1525 may also be part of a cloud of servers and may be stored in a distributed manner across a plurality of servers. There also may be an input/output bus 1520 that shuttles data to and from the various user input devices such as a microphone, a camera, a display monitor or screen, etc. The input/output bus 1520 also may control communicating with networks either through wireless or wired devices. In some embodiments, a scanning controller for running a scanning API may be located on the controller device 104. However, in other embodiments, the scanning controller may be located on server 120, or both the controller device 104 and the server 120. Of course, this is just one embodiment of the server 120 and additional types of servers are contemplated herein.

### Scanning Software and Applications

In some embodiments, the systems and methods described herein may also include one or more computer executable software applications (e.g., scanning application, tracking application, etc.) that may be run locally on one or more computing devices such as control devices 104, on a remote cloud server such as server 120, and/or on board the scanning device 102. The application may include one or more graphical user interfaces (GUIs) that may enable users (such as inspectors or other service providers) and/or customers and other users (e.g., building owners, maintenance personnel) to program and/or control the scanning device 102. In some embodiments, the application may determine a flight pattern and/or image and other sensor data capturing protocol based on information about a particular target structure or other object. For example, the scanning application may have access to public or private databases storing structure information such as dimensions, age, materials, inspection history, repair history, etc. In some embodiments, the scanning device 102 may perform an initial scan of the building 50 to determine physical features and other dimensions, and use that information to determine a flight plan and/or image capture plan. In some embodiments, the scanning device 102 and/or the application may access GPS to determine geographical location, which may be used to determine additional aspects of the structure's context, such as weather, exposure, and other environmental factors. In some embodiments, the application may use one or more of predictive analytics, machine learning, generative artificial intelligence (AI), and/or other artificial intelligence techniques to determine the flight plan, the image and other sensor data capture plan, and other information specific to the particular structure (e.g., structure type, materials, locations, etc.). The flight plan and/or sensor capture plan may also or alternatively be manually determined and entered by an operator or other user based on a visual inspection, prior knowledge, or other information. The flight plan and image and sensor capture plan may then be executed by the scanning device 102 via manual control of the operator, autonomously, or semi-autonomously. In some embodiments, the application may provide the operator with real-time instructions for piloting the scanning device 102 around the building 50, such as via a GUI or audible instructions. In some embodiments, the application may provide a customer, service provider, or other user real-time or quasi-real-time updates on the progress of the data collection process.

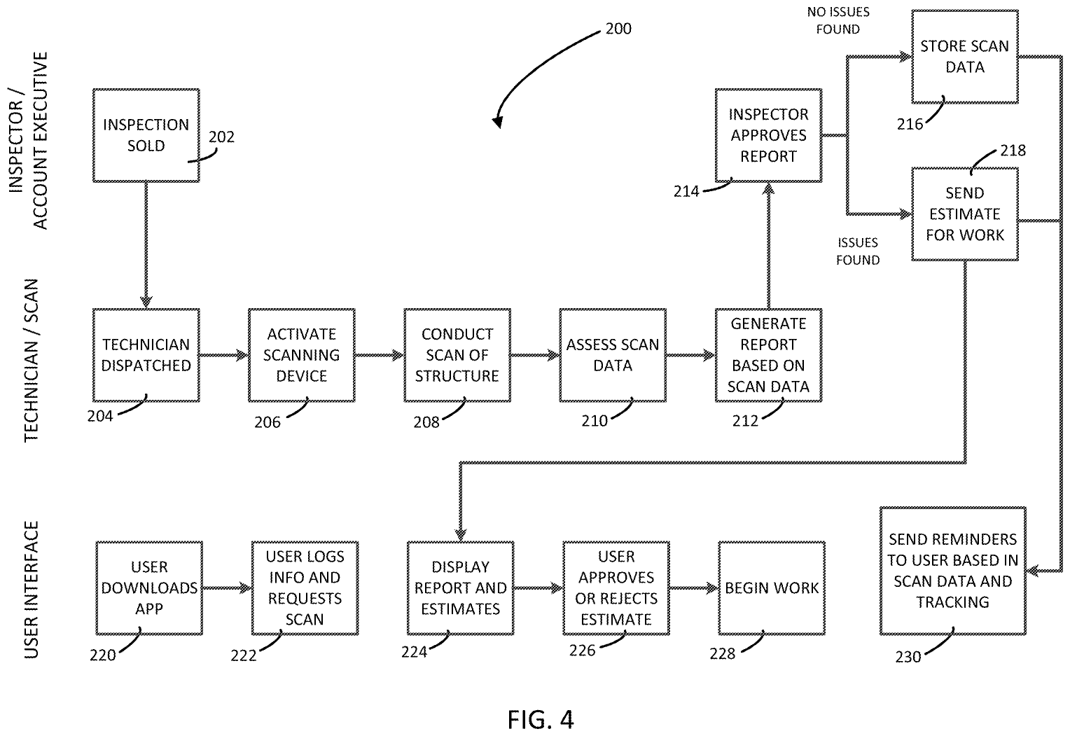

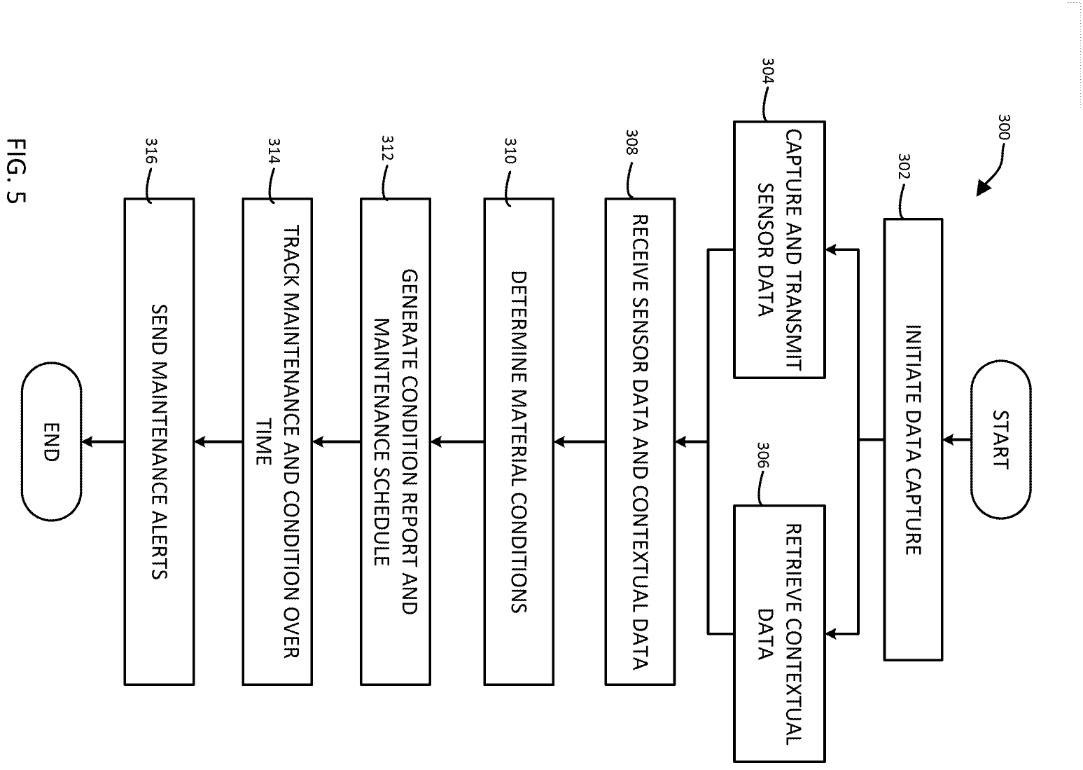

FIG. 4 is a flow chart 200 of an embodiment of a method of using the scanning system and application described herein, such as for a home or other building inspection. At 202, a home or other building inspection may be sold or otherwise scheduled. At 204, a technician and/or inspector may be dispatched to conduct the inspection using the scanning system to capture image and other sensor data about the structure, its materials, etc. In some embodiments, it will be understood that it may not be necessary to dispatch a technician, such as if the scanning system may be administered via a customer or other user's mobile computing device as the scanning device, such as a smart phone or tablet computer with built-in cameras and other sensors. In such embodiments, the customer or other user may act as the “technician” for the purposes of the disclosure. At 206, the technician may activate a scanning device, such as scanning device 102 or, in the case of a customer, use their mobile device via an application, and instruct it to initiate a scan and data capture of a home or other structure. At 208, the scanning device may conduct a scan, which may include flight patterns and image and/or other data capturing patterns as described herein. In some embodiments, a scanning pattern, flight pattern, and/or image capture pattern may be determined by assessing the dimensions and other properties of the structure, either visually on site or by accessing stored information in a database. In some embodiments, Al or other computational techniques may be used to determine an appropriate flight pattern and/or image and other sensor capture plan. At 210, the scanning device, controller, and/or remote server may access and assess the images and other scanning data captured during the scan and, at 212, provide a report of the scanning devices findings, such as via the scanning application. At 214, the technician, inspector, or other user may review the report, edit, and approve for the customer/homeowner. If no damage is found that may warrant repairs at that time, at 216, the data captured by the scanning device may be stored in the scanning application or in the appropriate database accessible by the scanning application. If one or more damaged areas may be located by the scan, at 218 the scanning application or the inspector may generate an estimate for repair or replacement of the damages substrate and send the estimate to the homeowner for review.

At 220, the homeowner or other user may download or otherwise access an external interface of the scanning application, and may setup up a profile such as by logging information about the target home or other building at 222. At 224, the homeowner or other user may receive the estimate provided by the scanning system, such as via the scanning application. At 226, the homeowner or other user may approve or reject the estimate, or may defer to a later date. At 228, once the homeowner or other user approves of the repairs or other work to be completed to address damage or other issues identified by the scanning system, production, repairs, or other maintenance may began. At 230, reminders may be sent to the homeowner or other user about subsequent scans, about unrepaired damage, etc. In some embodiments, even if no initial damage may have been identified by the scanning system, the application may store the condition of the building materials determined based on the scan. The application may then determine estimated times at which particular aspects of the scanned structure may benefit from maintenance, repairs, replacement, or other attention. In some embodiments, the application may use computational techniques such as reference tables, machine learning, Al, etc., to generate a maintenance schedule that may take into account the particular condition, location, and other contextual factors (e.g., weather, age, environment, etc.). In some embodiments, the maintenance schedule and associated reminders may be based on an initial scan of the structure and the particular condition, age, soundness, etc., of the structure's materials.

FIG. 5 shows an embodiment of a flow chart for a method 300 of using an embodiment of the scanning system that may be applied in a variety of contexts, such as to identify material conditions of buildings, bridges, homes, vehicles, utilities and other objects and structures, as well as individual components of those structures. At 302, the method may include initiating a data capture and/or data capture plan, such as via a dedicated software application and/or via a scanning device. Initiation of the data capture may be conducted by any user with a scanning device, such as an inspector, maintenance or other service provider, customer, homeowner, etc. In some embodiments, a customer may initiate the data capture using a scanning device that may be a personal electronic device that includes sensors, such as a smart phone, tablet computer, camera, aerial drone, etc. In some embodiments, the sensors may include cameras, optical sensors, infrared sensors, densitometers, light sensors, proximity sensors, ultrasound sensors, radar, LIDAR, etc. At 304, the method may include capturing sensor data with the scanning device via its one or more sensors, and transmitting the sensor data to the application for processing. In some embodiments, the application may be on the scanning device and may also be overseeing the sensor capture itself. In some embodiments, the application may be remote from the scanning device, such as on a remote control device (e.g., control device 104 in FIG. 1) or on a cloud-based server in communication with the scanning device, either directly or indirectly. In some embodiments, the sensor data may include image data, material conditions, data on vibrational analysis, component conditions, etc. At 306, the method may include retrieving other contextual date related to the structure or other object being scanned. In some embodiments, the scanning device, application, or other connected hardware or software components may access GPS data to determine a geographical location of the structure and additional information available via one or more public or private databases, or information that has been entered by a user. For example, the method may include determining applicable information regarding environmental, weather, exposure, temperature fluctuations, humidity, etc., based on the GPS location and other contextual clues. In some embodiments, the method may include using generative Al or other computational tools to search one or more information repositories (e.g., the internet), for additional applicable information about the structure and its dimensions, material make up, age, type, components, etc.

At 308, in some embodiments, the application may receive the sensor data from the scanning device and retrieve the contextual data from the application itself or from other remote sources, such as a cloud server. In some embodiments, the scanning device may perform its own data analysis or partial data analysis prior to transmitting data to the application, a controller device, remote server, and/or other computing resources. In some embodiments, the application may produce a 2D or 3D rendering of the scanned structure or other object (e.g., a building 50 in FIG. 1) based on the received sensor data and/or contextual data. At 310, the method may include determining material conditions of the structure, such as a building substrate or other materials, based on the received sensor data. In some embodiments, the determination of material conditions may be produced based on the sensor data using one or more of predictive analytics, machine learning, generative artificial intelligence (AI), and/or other artificial intelligence techniques as described herein. Alternatively or additionally, other or more traditional computing techniques may be used as known by those skilled in the art.

At 312, the method may include generating a condition report of the structure's materials, such as building substrates. In some embodiments, the report may include visual or other indications of a condition of the scanned structure in the 2D or 3D rendering of the structure, such as condition of its substrates and other materials. In some embodiments, the report may additionally or alternatively be a list of structural and/or non-structural components and their conditions, or any other appropriate presentation of the determined material conditions. In some embodiments, the report may include areas of damage that may have been identified via the sensor data. In some embodiments, at 312, the method may also include generating a maintenance schedule based on the sensor data and/or contextual data retrieved by the application. For example, the application may determine that a particular material on a structure may currently be in satisfactory condition. However, based on the current material condition, the material type, material age, etc., and based on environmental factors such as weather, humidity, exposure to elements due to structure shape, etc., the application may determine that the particular material may warrant maintenance in a certain time frame (e.g., 2 years, 5 years, etc.). The time frames for maintenance may, in some embodiments, depend on a variety of factors specific to the material itself and/or to contextual data specific to the structure and even the particular materials location on the structure or role in the structure (e.g., exterior, interior, protected, unprotected, climate controlled, etc.).

In some embodiments, the application may include an internal (e.g., operator) interface and an external (e.g., customer) interface. The internal interface may run on an operator's computing device, such as the control device 104 or other computing device, or may be hosted on a remote server and accessed via the internet or another communications network. In some embodiments, the internal interface may allow inspectors or other operator technicians to complete and review their inspections using the scanning system 100 and share them with the customer or other interested parties. Using the internal interface, the inspector may also create and send estimates for providing repairs or other solutions for the problems identified by the scanning system.

In some embodiments, the external interface may run on a user computing device, or be accessible by a user computing device such as via a remote cloud server. For example, a homeowner, customer, or other interested party may access the external interface and may log into an account associated with the user, the particular structure (e.g., home or other building), or a particular inspection. In some embodiments, the user may access information about the structure, such as the 2D or 3D renderings of the structure or other data related to scanning results. The external interface may provide access to GUIs that may allow the user to virtually inspect the structure based on the sensor data and see the damaged areas or other conditions. In some embodiments, the damaged areas may be indicated graphically, such as via highlighting or other visual indicator. The user may also view any estimates that an inspector or other service provider has provided via the application, accept them, pay a deposit, pay bills, view schedules, and follow the subsequent progression of any repair projects requested. In some embodiments, the external interface may allow the user or other customer to view and/or compare past/historical scans of the structure. If multiple scans have occurred, the homeowner and the inspector may, using the internal or external interfaces, see the progression of the structure, its materials and substrates, and compare conditions over time.

At 314, in some embodiments, the method may include tracking maintenance of the structure over time and the conditions of the structure and its materials, such as based on sensor data, contextual data, and/or the passage of time in view of the data available. For example, based on a particular type of substrate (e.g., species of wood, paint coating, etc.) that may have been used on a structure and that substrate's sensed condition at the time the sensor data was captured, the application may track the condition of that substrate over time. In some embodiments, the scanning system may use historical data stored in the scanning application or other database along with predictive analytics and Al techniques to project what the lifespan of a substrate and/or paint coating(s) is/will be, as well as when each particular substrate is likely to need maintenance to avoid costly repairs. In some embodiments, the application may also use contextual data specific to the structure to make those determinations, as particular environmental factors may extend or shorten the lifespan of certain structure materials. In some embodiments, at 316, the application may send alerts to users of previously diagnosed, but untreated areas that may contain projected additional damage and possibly associated costs if left untreated. In some embodiments, the application may send alerts to users indicating that, while maintenance may not have been warranted for a particular material at the time sensor data was collected, but that due to passage of time and additional use or exposure, repairs, replacement, or other maintenance may be warranted.

In some embodiments, the application may determine whether a repair of the substrate may be sufficient or whether replacement may be necessary or recommended based, for example, on the size/depth or other factors of the damage located during the scanning process, and/or other contextual factors. In some embodiments, the application may also educate users on proper maintenance cycles and help them make informed decisions about structure maintenance (e.g., homes, buildings, etc.). In some embodiments, the application may store substantially all pertinent maintenance data regarding the structure, including, for example, other maintenance related items, previous damage repairs, purchase dates & receipts, contractor, invoices, etc. In some embodiments, the application may be a substantially all-encompassing tool for all things related to maintenance of a structure or other object (e.g., home, building, vehicle, bridge, etc.). In some embodiments, the application's user interface may provide users with an ever-changing picture of a structure's maintenance health, allowing users to make informed and accurate decisions about structure maintenance that may result in increased maintenance efficiency, cost savings, safety, etc. In some embodiments, the applications may include an exchange wherein outside app developers may sell their software to application users through API and/or other integrations.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A system for assessing condition of materials, the system comprising:
a scanning device including a scanning vehicle and one or more scanning sensors; and
a control device in electronic communication with the scanning device, the control device including one or more processors and a memory containing processor-executable instructions that, when executed by the one or more processors, cause the one or more processors to:
transmit instructions to the scanning vehicle to move with respect to a structure,
transmit instructions to the one or more scanning sensors to capture data associated with one or more materials of the structure,
receive sensor data from the one or more scanning sensors, and
based on the sensor data, determine a condition of each of the one or more materials of the structure.

2. The system of claim 1, wherein at least one of the one or more scanning sensors is a densitometer.

3. The system of claim 2, wherein the sensor data includes images captured by the densitometer.

4. The system of claim 1, wherein the scanning vehicle is an aerial drone.

5. The system of claim 4, wherein the instructions to the scanning vehicle include a flight pattern.

6. The system of claim 1, wherein the control device determines the condition of each of the one or more materials of the structure by comparing a measured value of a material property to a baseline value of the material property.

7. The system of claim 6, wherein the material property is density.

8. The system of claim 1, wherein the control device uses predictive analytics to analyze sensor data and determine the condition of each of the one or more materials of the structure.

9. The system of claim 1, wherein the control device determines one or more suggested repairs based on the determined condition of the one or more materials.

10. The system of claim 9, wherein the control device determines an estimated cost associated with each of the one or more suggested repairs.

11. The system of claim 9, wherein the control device determines an estimated cost associated with delaying the one or more suggested repairs.

12. A computer-implemented method of assessing conditions of structure components, the method comprising:
determining, via a control device, a scanning pattern for a structure that includes one or more materials;
transmitting, from the control device to a scanning vehicle, the scanning pattern instructing the scanning vehicle to capture data associated with the one or more materials via one or more scanning sensors on the scanning vehicle;
receiving, from the scanning vehicle, sensor data from the one or more scanning sensors; and
based on the sensor data, determining, by the control device, a condition of each of the one or more materials of the structure.

13. The method of claim 12, wherein at least one of the one or more scanning sensors is a densitometer.

14. The method of claim 13, wherein the sensor data includes images captured by the densitometer.

15. The method of claim 12, wherein the scanning vehicle is an aerial drone.

16. The method of claim 15, wherein the scanning pattern transmitted to the scanning vehicle includes a flight pattern.

17. The method of claim 12 further comprising determining the condition of each of the one or more materials of the structure by comparing a measured value of a material property to a baseline value of the material property.

18. The system of claim 17, wherein the material property is density.

19. The system of claim 12, wherein the condition of the one or more materials of the building is determined using predictive analytics.

20. A system for assessing condition of structure materials, the system comprising:
a scanning device including one or more sensors; and
a control device in electronic communication with the scanning device, the control device including one or more processors and a memory containing processor-executable instructions that, when executed by the one or more processors, cause the one or more processors to:
determine a scanning pattern for a structure that includes one or more materials,
transmit the scanning pattern to the scanning device,
retrieve contextual data associated with the structure,
receive sensor data from the one or more sensors,
based on the sensor data, determine a condition of each of the one or more materials of the structure by comparing a measured value of a material property to a baseline value of the material property, and
based on the senor data and the contextual data, determine a maintenance schedule for the structure.
